(19) United States
(12) Patent Application Publication
(10) Pub. No.: US 2026/0021005 A1
(43) Pub. Date: Jan. 22, 2026

(54) TERMINAL DISPLAY FOR A SYSTEM TO ASSIST WALKING

(71) Applicant: ABLE HUMAN MOTION, S.L., Barcelona (ES)

(72) Inventors: Joan LOBO PRAT, Barcelona (ES); María Helena LOPEZ MATAS, Barcelona (ES); Guim PEDRERO TOBELLA, Barcelona (ES); Pau MOREY OLIVÉ, Barcelona (ES)

(21) Appl. No.: 19/108,364

(22) PCT Filed: Sep. 12, 2023
(86) PCT No.: PCT/IB2023/000530

§ 371 Date: Mar. 3, 2025

Related U.S. Application Data
(60) Provisional application No. 63/405,603, filed on Sep. 12, 2022.

(51) Int. Cl. A61H 3/00; A61H 1/02

(52) U.S. Cl. CPC A61H 3/00; A61H 1/0262; A61H 2201/0107; A61H 2201/5007; A61H 2201/5043; A61H 2201/5069; A61H 2201/5084; A61H 2230/62

(57) ABSTRACT

A terminal display for a walking assistance system can be removably attached to the system. The system comprises can include segments including lumbar, thigh, shank, and optionally, foot segments. The system integrates multiple sensors to determine each segment's relative position and a control unit to process the user center of mass (COM) relative to their feet position. The display connects wirelessly to the control unit and presents the user's center of mass, preferably relative to their feet position, which is also displayed, enhancing this way walking assistance capabilities.

### FIELD

The present invention relates to the field of wearable robotic systems, specifically walking assistance technologies and their associated display and communication systems. More particularly, the present invention relates to a visual display designed to interface with a system to assist walking, facilitating real-time monitoring and representation of the center of mass of the user wearing the system relative to the position of the user's feet.

### BACKGROUND

Exoskeletons are increasingly relevant devices in the field of physical therapy, primarily employed to assist individuals with motor neurological impairments. These devices are designed to facilitate gait training, enhancing mobility and restoring physiological functions. In clinical settings, their operation and management typically require the presence of specialized clinicians.

Real-time feedback regarding the device's operational state and its current configuration is desirable for both patients and clinicians, in order to provide a safe utilisation of the exoskeleton. In particular, users need to know the exoskeleton's current state to mitigate risks prior to performing actions such as standing up, walking, or turning, to avoid potential falls. Furthermore, this feedback from the device state must be continuously updated in real time during the exoskeleton operation.

Visual feedback during exoskeleton utilization is a powerful tool for optimizing the device's functionality. Exoskeleton users frequently exhibit restricted or absent sensations in their lower limbs, resulting in compromised proprioception and spatial recognition. The incorporation of continuous visual feedback can assist them to compensate for this proprioceptive deficiency, enhancing the device's safety at the same time. Said continuous feedback may be extremely beneficial for therapists as well, providing them a precise and objective instrument that allows for the accurate correction of patient posture and guidance during the entirety of the gait training and rehabilitation phases. The capability to offer quantifiable visual insights instantaneously augments the exoskeleton's operational efficacy for both therapists and patients.

Known devices provide visual feedback which involves the use of a patient-worn watch display. While this watch display offers the patient a direct view, it poses operational challenges. In order to view the watch during operation, the patient must momentarily stop, relying on a single crutch for support in order to raise the arm displaying the watch. This action not only disrupts the flow of movement but also introduces potential balance complications. Moreover, the small size of the watch screen severely restricts the information displayed, providing only a cursory overview of the device's state with limited insights into additional settings and excluding comprehensive visual feedback regarding device operation.

Other systems rely on separate devices—be it mobile phones, tablets, or laptops—to provide visual feedback. However, these standalone devices introduce their own set of limitations. For therapists, maintaining continuous visual contact with these displays while ensuring patient safety proves challenging. The prevalent practice involves therapists positioning themselves behind the exoskeleton for support, which inherently prevents simultaneous observation of the separate feedback device. If a tablet or laptop is employed, it is typically stationed on a nearby table, necessitating the therapist to divert attention and physically approach it for a clearer view. Similarly, mobile phones, often kept in a therapist's pocket, require the therapist to disengage from supporting the patient to access the feedback, invariably prompting the patient to cease walking.

Additionally, certain commercial exoskeletons have incorporated touch-screen controllers or displays connected to the exoskeleton via cables. These displays are often attached to the exoskeleton's rear. This cabled connection, while providing a more integrated feedback solution, still presents substantial viewing impediments. Therapists observing from different points other than directly behind the exoskeleton—such as the front or lateral sides—find their view of the display obstructed. Similarly, the patient loses the ability to view this screen while in operation.

Given the explored limitations and trade-offs of existing systems within exoskeleton devices, it is clear the need of a solution that can provide accurate and useful information without restricting or limiting the patient exercise or the therapist assistance. Such a solution must prioritize real-time, continuous visual feedback, ensuring both the clinician and patient can access crucial device information without disruption to the therapeutic process. Addressing these shortcomings is paramount to optimizing exoskeleton usage and enhancing the safety and efficacy of rehabilitative interventions.

### SUMMARY

In a first aspect of the invention, a terminal display (1) adapted to be removably attached to a system to assist walking (4) is disclosed.

Said terminal display (1) is adapted to be removably attached to a system to assist walking (4), wherein the system to assist walking (4) comprises a) a lumbar segment, b) a pair of thigh segments, c) a pair of shank segments, and preferably a pair of foot segments, d) a plurality of sensors suitable to determine the relative orientation of each segment, and a control unit configured to compute the user's feet relative position from the signals received from the plurality of sensors. The terminal display (1) is characterised in that it is configured to display the position of the center of mass (COM) (10) of the user wearing the system to assist walking relative to the position of the user's feet (12).

In a preferred embodiment of the first aspect of the invention, the terminal display (1) is adapted to be removably attached to such a system to assist walking (4) through detachable means (3), and is configured to be wirelessly connected to the control unit.

In another preferred embodiment, the terminal display (1) is configured to be removably attached to the system to assist walking (4) through magnetic means (3).

In an alternative embodiment of the terminal display (1) of the invention, the position of the COM (10) relative to the position of the user's feet (12) is computed by the control unit.

In another preferred embodiment, the terminal display (1) further comprises a processing unit, and wherein the position of the COM (10) relative to the position of the user's feet (12) is computed by the processing unit of the terminal display (1).

In an alternative embodiment of the terminal display (1) of the invention, the system to assist walking (4) further comprises at least a pair of angle sensors suitable to measure or calculate the angle between a shank segment and a thigh segment, and at least a triplet of orientation sensors suitable to measure or calculate the orientation of the thigh segments and the lumbar segment. Also, the control unit is further configured for processing the angle sensors and the orientation sensors readings, and the position of the COM (10) relative to the position of the user's feet (12) is computed based at least on the angle's readings of each of the angle sensors, the roll and pitch angles readings of each of the orientation sensors, the length of the shank and thigh segments, the distance between the thigh segments at the hip level, and the height of the COM (10) of the user.

In a preferred embodiment of the terminal display (1) of the invention, the position of the COM (10) of the user is displayed as a top-view projection relative to the position of the user's feet (12).

In a more preferred embodiment of the terminal display (1) of the invention, the position of the COM (10) top-view projection relative to the position of the user's feet (12) is also computed based on the height and in the orientation of the COM (10) of the user.

In an even more preferred embodiment of the terminal display (1) of the invention, the height of the COM (10) of the user is computed based on the shank and thigh segments length measurements.

In another more preferred embodiment of the terminal display (1) of the invention, the position of the COM (10) top-view projection relative to the position of the user's feet (12) is computed in both the anterior-posterior and medial-lateral directions.

In an even more preferred embodiment of the terminal display (1) of the invention, the COM (10) top-view projection relative to the position of the user's feet (12), in the anterior-posterior direction, is computed as:

$$P r o {j}_{A P} = {P}_{COM\_AP} - \frac{{P}_{LeftFoot\_AP} + {P}_{R ightFoot\_AP}}{2} ;$$

wherein P_{COM_AP} is the position of the COM (10) projected in the anterior-posterior direction, P_{Left Foot_AP} is the position of the left foot projected in the anterior-posterior direction, P_{Right Foot_AP} is the position of the right foot projected in the anterior-posterior direction, and wherein each of the positions are computed according to a coordinate system.

According to an even more preferred embodiment of the terminal display (1) of the invention, the COM (10) top-view projection relative to the position of the user's feet (12) in the anterior-posterior direction, Proj_{AP}, is normalized, preferably by dividing over the distance between both feet (12), D_{Foot_AP}, projected in the anterior-posterior direction, more preferably wherein said distance D_{Foot_AP} is divided by a factor of two.

In another more preferred embodiment of the terminal display (1) of the invention, the COM (10) top-view projection relative to the position of the user's feet (12), in the medial-lateral direction is computed as:

$$P r o {j}_{M L} = {P}_{C O {M}_{-} M L} - \frac{{P}_{{LeftFoot}_{-} M L} + {P}_{R i g h t F o o {t}_{-} M L}}{2} ;$$

wherein P_{COM_ML} is the position of the COM (10) projected in the medial-lateral direction, P_{Left Foot_ML} is the position of the left foot projected in the medial-lateral direction, P_{Right Foot_ML} is the position of the right foot projected in the medial-lateral direction, and wherein each of the positions are computed according to a coordinate system.

According to an even more preferred embodiment of the terminal display (1) of the invention, the COM (10) top-view projection relative to the position of the user's feet (12), in the medial-lateral direction, Proj_{ML}, is normalized, preferably by dividing over the distance between both feet (12), D_{Foot_ML}, projected in the medial-lateral direction, more preferably wherein said distance D_{Foot_ML} is divided by a factor of two.

In another more preferred embodiment of the terminal display (1) of the invention, the coordinate system is centered in the middle of the hip of the user, preferably wherein the hip of the user is computed as the line between the thigh segments at the hip level.

In another preferred embodiment of the terminal display (1) of the invention, the at least one pair of angle sensors are encoders located at the knee joints connecting respectively a shank segment and a thigh segment.

In another preferred embodiment of the terminal display (1) of the invention, the at least triplet of orientation sensors are inertial measurement unit sensors.

In an alternative embodiment of the terminal display (1) of the invention, one or more of the pair of shank and thigh segments are adjustable in length, wherein the distance between the thigh segments at the hip level is adjustable, and wherein the control unit is further configured for receiving these length and distance values.

In another preferred embodiment of the terminal display (1) of the invention, the magnetic means (3) of the system to assist walking (4) are personalized to each respective system (4), preferably through a combination of magnetic polarizations.

In a preferred embodiment of the invention, the terminal display (1) is configured to display and/or store system status information.

In another preferred embodiment of the invention, the terminal display (1) is configured to display and/or store biomechanical information, usage metrics or performance metrics.

According to another preferred embodiment of the invention, the terminal display (1) is configured to display and/or store gait settings, preferably wherein it allows adjusting gait settings.

In an alternative embodiment of the terminal display (1) of the invention, the system to assist walking (4) further comprises a projector, preferably wherein the projector is comprised in the front of the system (4).

According to another embodiment of the invention, the terminal display (1) may comprise an external screen, a projector, a virtual reality headset or an augmented reality headset, preferably connected to the system (4) wirelessly.

### BRIEF DESCRIPTION OF THE DRAWINGS

To enable a better understanding of the present disclosure, and to show how the present disclosure may be carried out, reference will now be made, by way of example only, to the accompanying schematic drawings, wherein:

FIG. 1 shows an example of a display adapted to be removably attached to a system to assist walking, according to one or more embodiments of the invention.

FIG. 2 shows an example of a display detached from a system to assist walking (A), and the display removably attached to the system to assist walking (B), according to one or more embodiments of the invention.

FIG. 3 shows a display configured to display the position of the center of mass (COM) of the user relative to the position of the user's feet, according to one or more embodiments of the invention.

FIG. 4 shows a sign convention diagram employed to calculate the position of the COM according to one or more embodiments of the invention.

### DETAILED DESCRIPTION

### Definitions

It must be noted that, as used herein, the singular forms “a”, “an”, and “the”, include plural references unless the context clearly indicates otherwise. Further, unless otherwise indicated, the term “at least” preceding a series of elements is to be understood to refer to every element in the series. Those skilled in the art will recognize or be able to ascertain using no more than routine experimentation, many equivalents to the specific embodiments of the invention described herein. Such equivalents are intended to be encompassed by the present invention.

It is noted that the term “about”, as used herein, refers to +/−30%, preferably +/−20%, preferably +/−15%, more preferably +/−10%, of the indicated referred value.

As used herein, the conjunctive term “and/or” between multiple recited elements is understood as encompassing both individual and combined options. For instance, where two elements are conjoined by “and/or”, a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein the term “comprising” can be substituted with the term “containing” or “including” or sometimes when used herein with the term “having”. Any of the aforementioned terms (comprising, containing, including, having), whenever used herein in the context of an aspect or embodiment of the present invention may be substituted with the term “consisting of”, though less preferred.

When used herein “consisting of” excludes any element, step, or ingredient not specified in the claim element. When used herein, “consisting essentially of does not exclude materials or steps that do not materially affect the basic and novel characteristics of the claim.

The term “exoskeleton”, in the context of the invention, refers to a wearable mechanical system specifically designed to assist in walking and gait training. This system primarily targets the lower limbs and the back, preferably the lower or lumbar segment, but may also include middle or upper segments, to provide mechanical assistance, stability, or support. Complementary devices such as crutches may also be comprised within the term exoskeleton when associated to a wearable mechanical system as above-defined. The exoskeleton may be operatively connected to control units or software that enable its functions.

The term “system to assist walking”, in the context of the invention, refers to a wearable mechanical system specifically designed to assist in walking and gait training. This system primarily targets the lower limbs and the back, preferably the lower or lumbar segment, but may also include middle or upper segments, to provide mechanical assistance, stability, or support, such as crutches. The system to assist walking may comprise exoskeletons or any mechanical, electromechanical, or software-driven solution designed to aid, enhance, or support walking and gait training functions, such as lower limb braces, walker devices, wheeled or non-wheeled supports and/or programmable foot orthotics.

The term “terminal display”, in the context of the invention, refers to any electronic visual interface capable of presenting information, that may be generated by a computing device and/or a processor, wherein the computing device and/or processor may be comprised in the display itself. The term “terminal display” comprises, but is not limited to, mobile phones, tablets, laptops, desktop monitors, televisions, smartwatches, projectors, digital signage, screens, virtual reality headsets, augmented reality headsets, and automotive displays. The display may also comprise or be operatively connected to a set of instructions or software configured to control the visual interface. The display may comprise LED arrangements, liquid crystal displays (LCDs), organic light-emitting diode (OLED) screens, electronic ink (e-ink) displays, cathode ray tube (CRT) displays, plasma display panels (PDPs), quantum dot light-emitting diode (QLED) screens, microLED displays, digital light processing (DLP) screens, laser phosphor displays (LPD), electroluminescent displays (ELD), field emission displays (FED) and other visual output devices. It is noted that any combination of terminal displays (1) herein mentioned may be employed simultaneously or alternatively, therefore adapting to different situations.

The term “lumbar segment”, in the context of the invention, refers to a mechanical or electromechanical component specifically designed to support, stabilize, or aid the lumbar region of the back.

The term “thigh segment”, in the context of the invention, refers to a mechanical or electromechanical component tailored to encompass, support, or assist the upper leg area between the hip and the knee. This segment may be operatively connected to control units, software, or sensors that enable its functions and gather information on its position, movement, and/or angle of inclination.

The term “shank segment”, in the context of the invention, refers to a mechanical or electromechanical component designed to support or assist the lower leg area between the knee and the ankle. This segment may be operatively connected to control units, software, or sensors that enable its functions and gather information on its position, movement, and/or angle of inclination.

The term “foot segment”, in the context of the invention, refers to a mechanical or electromechanical component specifically tailored to encompass, support, or assist the foot area, which may include the heel, arch, the sole of the foot and the toes, in any possible combination. This may be operatively connected to control units, software, or sensors that enable its functions and gather information on its position, movement, and/or angle of inclination.

The term “detachable means”, in the context of the invention, refers to any mechanical, electromechanical, or magnetic component or set of components designed to removably attach two elements together. More preferably, it removably attaches a display to an exoskeleton or system to assist walking. Such means may utilize magnetic elements, potentially integrated within the exoskeleton, within the display, or within the case of the display, or they may also include or utilize alternative fastening mechanisms. Examples of such alternative mechanisms include, but are not limited to, snap fasteners, hook-and-loop fasteners, clamps, and/or screws. Additionally, the exoskeleton or system to assist walking may include mechanical supports designed to prevent the unintended detachment or falling of the display. These detachable means enable an easy attachment and detachment of the display.

The term “center of mass”, referred to as “COM”, in the context of the invention, refers to a calculated or estimated point or area representing the spatial location where the mass of the patient wearing the exoskeleton or system to assist walking is concentrated, or wherein the projection over a surface of the mass of the patient is concentrated. This point or area may be displayed on the electronic visual interface of the system, serving as an approximate representation of the individual's balance and mass distribution. Although the center of mass may be typically depicted as a circle on the display, it may also be represented by various other shapes or graphical indicators. The calculation or estimation is derived from sensor data gathered from the exoskeleton or the system, and may comprise, but is not limited to, sensor inputs related to position, angle, orientation, and/or force exerted on the segments

The term “triplet” is preferably understood as a set of three interconnected components or elements. In the context of the present invention, the components or elements are preferably sensors operatively connected to the system to assist walking or exoskeleton.

The term “Anterior-posterior direction”, in the context of the invention, refers to the linear axis extending from the front (anterior) to the back (posterior) of a biological organism or a mechanical structure configured to interface with such an organism. Along this axis, movement oriented towards the front of the organism, corresponding to forward progression during walking or gait, is termed as “anterior” movement. Conversely, movement oriented towards the back of the organism, corresponding to backward progression during walking or gait, is termed as “posterior” movement. This anterior-posterior direction serves as the principal axis for defining forward and backward locomotion in the context of assisted walking technologies, such as exoskeletons. It is orthogonal to the medial-lateral axis, which extends from one side to the other of the organism, and the superior-inferior axis, which extends from the top to the bottom of the organism.

The term “Medial-lateral direction”, in the context of the invention, refers to the linear axis extending from the inner side (medial) to the outer side (lateral) of a biological organism or a mechanical structure expressly configured to interact with such an organism. Along this axis, movement directed towards the inner side of the organism is classified as “medial” movement, while movement directed towards the outer side of the organism is classified as “lateral” movement. This axis is not only important for defining lateral steps or sideways motion, but also serves a role in evaluating the lateral displacement of the feet relative to the body during forward or backward walking and gait. The medial-lateral direction is orthogonal to the anterior-posterior axis, which predominantly governs forward and backward locomotion, and the superior-inferior axis, which extends from the top to the bottom of the organism.

The term “top-view projection”, in the context of the invention, refers to a graphical representation displayed on a terminal display, where the center of mass of a user wearing a system to assist walking is visually depicted in the transverse plane with an overhead perspective. This overhead or “top-down” view is preferably designed to present the position of the user's center of mass relative to the position of the user's feet, projected on a reference plane or area within which the user is operating or walking.

### DESCRIPTION

Exoskeletons have emerged as promising tools in physical therapy, aiding those with motor neurological impairments through gait training. While their application has shown promise, the necessity for real-time feedback is evident, as it ensures that both patient and clinician are constantly aware of the device's operational state to prevent accidents. However, current feedback systems, ranging from patient-worn watch displays to separate digital devices, present significant challenges. For instance, they may disrupt the therapeutic workflow, offer limited information, or prove impractical for therapists to monitor while assisting patients. Moreover, fixed, cable-connected display solutions, though more integrated, hinder optimal viewing for both patients and assisting therapists.

The described inadequacies highlight the necessity of an advanced and efficient feedback system that, in addition, integrates seamlessly with the exoskeleton's operation. Such a system should provide real-time and continuous visual feedback, allowing clinicians and patients unrestricted access to essential device information. This innovation would not only optimize the therapeutic potential of exoskeletons but also significantly elevate their safety and operational efficacy.

Here we provide a solution to overcome these problems, by providing real-time visual feedback of the system (4) status, such as, but not limited to, biomechanical information, usage, and performance metrics, through a display (1) and a software application, wherein said display (1) may be a mobile phone, a tablet, or any other portable screen. In particular, the display (1) shows a representation of the center of mass of the user (COM) (10) in real time, including during the usage of the system (4), allowing the clinician to correct the movements and redirect the training in real time, and the user to get a more precise understanding of their development. Additionally, the terminal display (1) may be removably attached to the system to assist walking (4), allowing the clinician to obtain the information displayed while assisting the walking exercise with both hands, and also to show it to the patient or other clinicians if necessary.

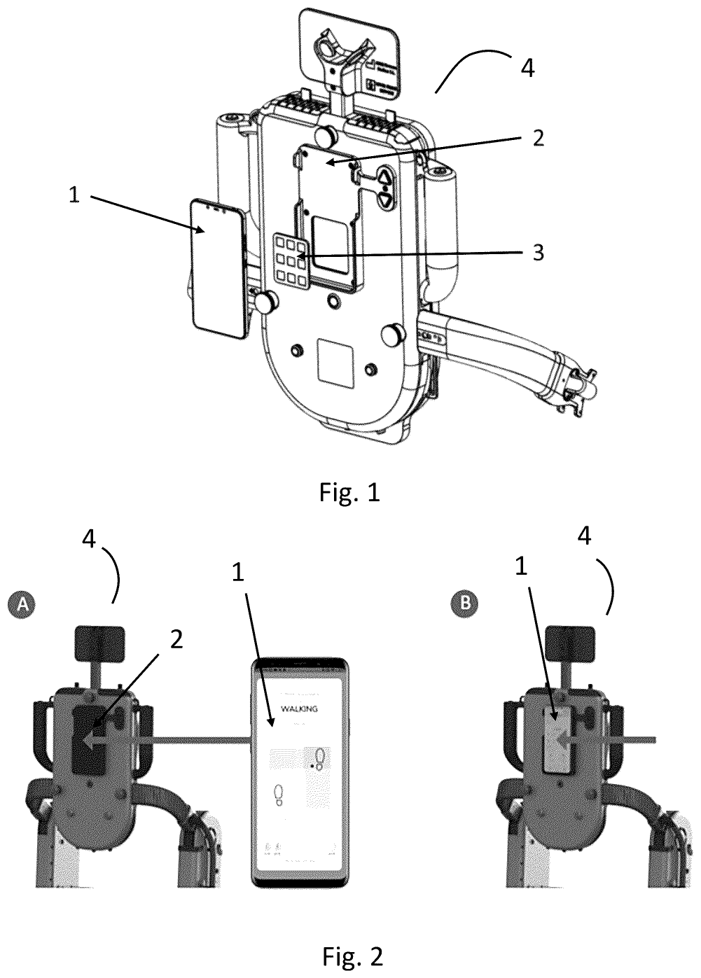

A first aspect of the invention, as described with reference to FIG. 1, relates to a terminal display (1) adapted to be removably attached to a system to assist walking (4), wherein the display (1) is configured to display the position of the center of mass (COM) of the user relative to the position of the user's feet.

It is noted that the terminal display (1) may comprise a broad range of electronic visual display technologies and devices capable of presenting information in a graphical or textual format. Such technologies may include, but are not limited to, Liquid Crystal Displays (LCD), Light-Emitting Diode Displays (LED), Organic Light-Emitting Diode Displays (OLED), and other emerging or existing display technologies. Moreover, the terminal display (1) also may also comprise any device equipped with a screen capable of rendering visual output, including but not limited to smartphones, tablets, Personal Digital Assistants (PDAs), laptops, projectors, and other handheld or stationary devices with visual display capabilities that are fit to be attached to a walking assisting system (4), preferably to its rear. Therefore, the term “display” should be understood in its broadest sense, incorporating all such variants and configurations, unless explicitly specified otherwise.

In some embodiments, the system to assist walking (4) may comprise a projector in addition to the terminal display (1). The display (1) and the projector may serve different purposes and can be positioned at various locations on the system (4). In some embodiments, the projector may be positioned at the front of the system (4). It may project visual cues or feedback directly into the user's field of view. The projector can serve various functions, such as indicating the next steps, enhancing balance by showing the position of the center of mass (10), or providing real-time feedback on posture and gait. In some embodiments, the projector may also utilize adaptive technologies to change the projected information based on real-time data. For instance, if the system (4) detects instability in the user's walking pattern, it may project visual cues aimed at correcting this.

Advantageously, the inclusion of both a display (1) and a projector in a system to assist walking (4) enhances its utility by allowing for diverse methods of delivering information and feedback, thus making the system (4) more versatile for both the clinician and the patient.

It is further noted that the system to assist walking (4) may comprise a wide array of mechanical, electromechanical, or robotic devices and technologies designed to aid, support, or enhance the walking or gait capabilities of a user. Such systems may include, but are not limited to, exoskeletons, orthotic devices, powered or unpowered limb supports, and wearable assistive technologies. Specifically, these systems are constructed to interface with the lower extremities of the human body, including the legs and preferably the feet, and may also extend to include supportive structures for the back or spine, the head or the upper limbs. The system (4) may be designed for various purposes including rehabilitation, gait training, mobility enhancement, and other applications where assisted walking or gait functionality is required. Therefore, the term “system to assist walking” should be construed in its broadest sense, encompassing all devices and technologies that align with the aforementioned functionalities, unless explicitly specified otherwise.

The system to assist walking (4) may comprise a lumbar segment, a pair of thigh segments, a pair of shank segments, a pair of foot segments, a plurality of sensors suitable to determine the relative orientation of each segment, and a control unit configured to compute the user's feet (12) relative position from the plurality of sensors.

It is noted that the system (4) may integrate different segments, alone or in combination, as long as it serves the purpose of assisting during gait training or walking, and they may be comprised in a bigger or longer segment that encompasses two or more of the segments previously mentioned. Therefore, it may comprise one or more segments for each leg, for instance it may comprise a whole leg segment, a foot segment, a shank segment, a thigh segment, a lumbar segment, a middle back segment, an upper back segment, a whole back segment, a head segment and/or segments for the upper limbs, such as arms, or any combination thereof. For example, instead of a lumbar segment it may comprise a medium back, upper back, whole back segment or any combination thereof. The segments in question may be constructed from a variety of materials and may exhibit different mechanical properties. They may be rigid, offering structural support, or flexible, allowing for a degree of movement and adaptability. Segments may also be configured to rotate or articulate with respect to each other, or they may be integrated into larger, composite segments that serve the function of multiple individual segments. Therefore, the term “segments” should be understood in its broadest sense to include any mechanical, electromechanical, or robotic components or assemblies that are capable of interfacing with the human body for the purpose of assisting walking or gait, irrespective of their number, combination, material composition, or mechanical properties, unless explicitly specified otherwise.

It is additionally noted that the system to assist walking may comprise configurations where traditional or defined “segments” are not employed. In such instances, sensors may be directly attached to the anatomical limbs of the user via various attachment means, including but not limited to belts, straps, adhesive materials, or other fastening mechanisms. They may adopt these configurations as long as they serve the purpose of provide visual feedback of the gait training or walking process of the patient to aid, enhance, or train walking or gait. These directly-attached sensors may be capable of fulfilling roles similar to those served by sensors integrated into defined segments. They may monitor various parameters related to the relative positions, movements, and orientations of anatomical segments, notably the lower limbs and potentially the back or spine. This sensor data may be connected to a control unit, either integrated into the system (4) or communicating wirelessly, for the purposes of computation and analysis. Therefore, an alternative system (4) may provide visual feedback on its status, including but not limited to information regarding the gait patterns, assessment of the patient's center of mass, and the relative position of the patient's feet (12) with respect to their center of mass. Such feedback may be displayed on a variety of electronic visual displays, in accordance with the broad definition of the term “display” as previously defined.

It is also noted that the sensors may comprise a broad category of sensing devices and technologies integrated into or used in conjunction with said system (4) for the purpose of determining the relative positions, movements, and orientations of various anatomical segments. These segments principally include, but are not limited to, the lower limbs such as the thighs, shins, and feet, as well as supportive structures of the back or spine. Types of sensors may encompass, but are not limited to, angle sensors, orientation sensors, accelerometers, gyroscopes, magnetometers, potentiometers, force sensors, pressure sensors, optical sensors, and other emerging or existing sensing technologies. These sensors are capable of measuring a range of kinematic and kinetic variables including, but not limited to, angular velocity, acceleration, force, torque, orientation, and displacement. The acquired data aids in assessing the state and motion of the lower limbs and back, thereby enabling the precise control, adjustment, and monitoring of the assistive walking or gait system.

It is further noted that the control unit may comprise a comprehensive array of computing hardware, firmware, and/or software modules designed to manage, coordinate, and control the functionalities of the walking assistive system, such as an exoskeleton. Preferably, the control unit is configured to receive input data from a plurality of sensors integrated into or wirelessly communicating with the system to assist walking (4). The control unit may include microcontrollers, microprocessors, digital signal processors, application-specific integrated circuits (ASICs), field-programmable gate arrays (FPGAs), or other computational elements capable of executing algorithms and control logic. Its primary function involves computing the relative positions of the user's feet (12) and other segments based on the input received from the plurality of sensors. The computed data may then be used to facilitate real-time adjustments, actuation, and monitoring of the exoskeleton to assist in walking or gait training.

Therefore, in a preferred embodiment of the first aspect of the invention, the system to assist walking (4) comprises a lumbar segment, a pair of thigh segments, a pair of shank segments, and preferably a pair of foot segments, a plurality of sensors suitable to determine the relative orientation of each segment, and a control unit configured to compute the user's feet (12) relative position from the signals received from the plurality of sensors, wherein the display (1) is configured to display the position of the center of mass, herein after referred to as “COM”, of the user wearing the system to assist walking (4) relative to the position of the user's feet.

Advantageously, the inclusion of a terminal display, characterized by its ability to showcase the position of the center of mass (COM) of the user relative to the position of the user's feet, presents distinct advantages for both the clinician and the patient. For the clinician, this specialized display (1) provides real-time, quantifiable data that improves the assessment of the user's gait patterns, stability, and overall alignment. It allows for immediate adjustments to the system's settings or the training regimen, thereby offering a more targeted and effective approach to rehabilitation or gait training. This can be particularly beneficial in identifying and correcting issues related to balance, coordination and weight distribution, factors that are critical to the success of the assistive system. For the patient, the visual feedback regarding their center of mass relative to their feet (12) serves as an invaluable tool for self-awareness and corrective action. It empowers users to understand the biomechanics of their movement better, instilling confidence and promoting active participation in their own recovery or training process. The real-time visual representation of the COM (10) aids in the internalization of proper gait mechanics, serving as a constant reminder and guide during the walking or training session.

In a preferred embodiment of the first aspect of the invention, a terminal display (1) adapted to be removably attached to a system to assist walking (4) is disclosed, wherein the system to assist walking (4) comprises a lumbar segment, a pair of thigh segments, a pair of shank segments, and preferably a pair of foot segments, a plurality of sensors suitable to determine the relative orientation of each segment, and a control unit configured to compute the user's feet (12) relative position from the signals received from the plurality of sensors, characterised in that the display (1) is adapted to be removably attached to such a system to assist walking (4) through detachable means (3), preferably through magnetic means (3), and is configured to be wirelessly connected to the control unit, wherein the display (1) is configured to display the position of the center of mass of the user wearing the system to assist walking (4) relative to the position of the user's feet.

It is noted that the terminal display (1) is adapted to be removably attached by means of various detachable mechanisms, including but not limited to, magnetic means, hook-and-loop fasteners such as Velcro, quick-release clamps, bayonet mounts, slide-and-lock mechanisms, snap-fit connectors, threaded fasteners, lever-actuated suction mounts, and locking pins. These mechanisms may be selected based on their ease of use, security of attachment, and adaptability to different system (4) configurations. For example, magnetic couplings could offer a quick and tool-free attachment and detachment, whereas threaded fasteners might be employed for a more secure and robust connection. Lever-actuated suction mounts could provide flexibility in placement on smooth surfaces, while bayonet mounts may facilitate a quick twist-and-lock action for expedited attachment or removal. Therefore, the range of detachable mechanisms serves to enhance the modularity and flexibility of the terminal display's integration into the system to assist walking (4).

It is noted that the terminal display (1) is configured to be wirelessly connected to the control unit through a variety of communication protocols and technologies, including but not limited to Bluetooth, Wi-Fi, Zigbee, radio-frequency identification (RFID), Near Field Communication (NFC), and proprietary wireless communication standards. These wireless connections may be selected based on factors such as data transfer speed, range, power consumption, and compatibility with other system (4) components. For instance, Bluetooth might be chosen for its ubiquity and ease of pairing, while Wi-Fi could be preferred for higher data transfer rates. Zigbee could be utilized for its low power consumption, making it ideal for long-term use, and RFID or NFC could be employed for short-range, secure data transfers. It is also noted that in some embodiments the terminal display (1) may be connected through wires, as long as they are long enough and they allow the display (1) to be repositioned from the back of the system (4) to different locations in the system (4) such as the front or the laterals, or they allow the display (1) to be shown to the patient or to other clinicians.

Advantageously, the terminal display's features of being both removably attached and wirelessly connected to the system to assist walking (4) substantially increase its versatility, and allows for the clinician to use it more easily while assisting in the gait training at the same time. For instance, it can be positioned at the back of the system (4) or exoskeleton, since generally a clinician would assist from the rear, and provide visual feedback such as the COM (10) relative to the patient's feet (12) to the clinician in real time, while executing the gait training and exercises. At the same time, it can be removed from that position to be shown to the patient or to other clinicians, to provide them with visual feedback in real time, which may improve the performance of the patient by giving them objective and clear information. It also allows to be removed and to be repositioned elsewhere, so as to allow the clinician to assist from other angles or directions, such as from the laterals or the front. It could also allow the display (1) to be used with different exoskeletons to which it can connect, or, for example, to easily connect it to a computer that might be located in a different room, to store or analyse the gathered data during the exoskeleton usage. Therefore, it is this combination of features that significantly improves the overall utility and effectiveness of the system to assist walking (4). Features such as the detachable means, the wireless connection capabilities and the display of the COM (10), contribute and combine to improve the assistance provided to the patient. For instance, the wireless connection ensures versatility and uninterrupted data transmission, and the display of the COM (10), preferably attached to the rear of the system (4), allows manual real-time adjustments in the assistance provided by the clinician, and also allows software configuration changes and/or parameter adjustments based on the continuous monitoring.

FIG. 1 shows an example of a terminal display (1), the top and back segments of a system to assist walking (4), detachable means (3), and a mechanical support (2) wherein the terminal display (1) can be placed.

It is noted that in FIG. 1, the terminal display (1) is represented as a phone; however, other types of electronic displays, such as tablets or devices from various brands or manufacturers, could equally serve the same functional purpose. The system to assist walking (4) is portrayed as comprising a surface for the back and a surface as a headrest, but alternative embodiments could include different segment configurations, such as focusing on the lower back, or omitting the headrest, without deviating from the primary objective of assisting walking. Also, the detachable means (3), illustrated in FIG. 1 as a magnetic mechanism specifically adopting a square grid with nine magnet positions, represents just one example of a detachable means. Other configurations are feasible, including but not limited to, circular arrangements or different numbers of magnet positions, such as more or less than nine. Besides, magnets could be exclusively integrated into the phone case, in which case the mechanical support (2) on the system could be ferromagnetic, to facilitate attachment, or the system may comprise an electromagnet. Alternatively, the detachable means (3) could involve a single magnet or a plurality of magnets or other magnetic means (3) such as electromagnets in various combinations and configurations, while maintaining the same fundamental purpose of removable attachment, or, instead, not comprising any magnet and comprise a different type of detachable means (3) or a combination of them, such as snap fasteners, hook-and-loop fasteners, clamps, and/or screws, among many others. It is further noted that the mechanical support (2) depicted as having a fitting shape for holding the phone is not limiting. As a matter of fact, alternative forms that prevent unintentional detachment of the terminal display could be employed, such as clamps, brackets, or other shapes that conform to different terminal displays.

It is also noted that the mechanical support (2) may not be included in other embodiments of the invention, or it may be comprised in the detachable means (3).

FIG. 2 shows a system to assist walking (4) and a terminal display (1) adapted to be removably attached to said system (4), wherein in FIG. 2A the display (1) is detached from the system (4), and in FIG. 2B we can see the same display (1) removably attached to the system (4).

It is noted that the terminal display (1) is shown as being magnetically attached to a mechanical support (2) on the system to assist walking. However, the presence of this mechanical support (2) is not obligatory. The terminal display (1) could be directly attached to the system to assist walking (4) without the need for an intermediary mechanical support (2), employing other attachment mechanisms such as clips, brackets, or adhesive materials, among others. Moreover, the specific type and configuration of the system to assist walking (4) in the image are not limiting. Variants could include different designs, functionalities, or additional components that serve the essential purpose of aiding walking. Similarly, the size and form factor of the terminal display (1) are not restricted to those in the illustration; larger or smaller displays (1) could equally be used based on specific needs or preferences. Further, the positioning of the terminal display (1) when attached to the system (4) is not fixed. The terminal display (1) may be located at various heights, higher or lower, on the system (4), depending on the requirements of the clinician or the user. Additionally, the terminal display (1) may be attached not only at the center but also laterally on the system (4), allowing for different viewpoints, improving visibility and accessibility in certain exercises or usage modes. Therefore, the orientation could differ, including possible placements on lateral sides or a frontal surface if such is comprised in the system. Therefore, the configurations depicted in FIG. 2A and FIG. 2B are to be understood as exemplary and non-restrictive. The invention is not limited to these specific details but may be modified within the scope and equivalents of the appended claims.

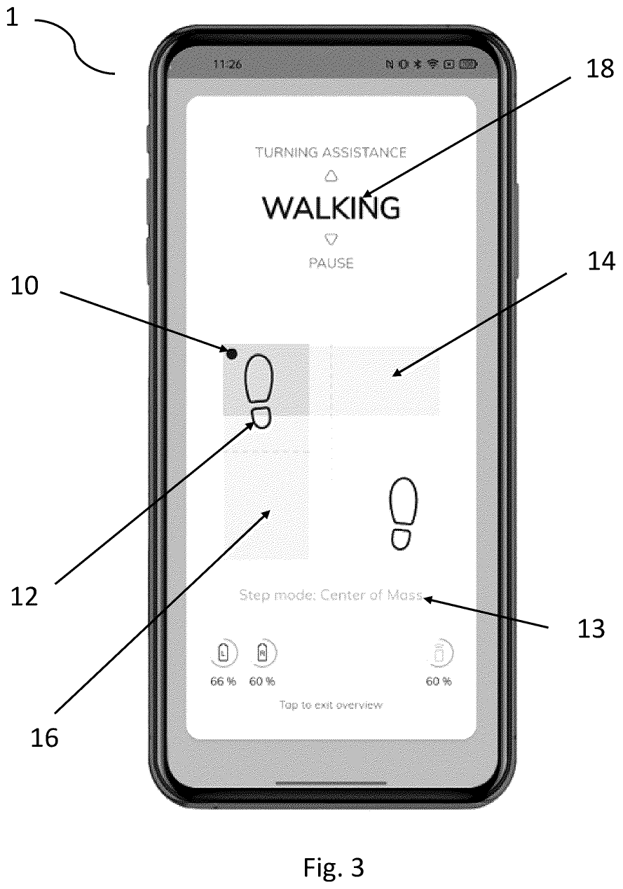

Image 3 shows a terminal display (1) according to one or more embodiments of the invention. There are different elements shown in the display (1) that may be represented differently in other embodiments of the invention. In FIG. 3, the display (1) is configured to show the center of mass (COM) (10) of the patient as a black point, however, said center of mass could be displayed differently in different embodiments, or even not shown at all even though it is calculated, if, for instance, it constitutes the center of the screen and the feet (12) position move relative to it. As a matter of fact, it could be displayed bigger or smaller, with different colours or different shapes, and comprise a point or even an area. Regarding the COM (10), the display may be configured to provide feedback as a function of the position of the COM (10) relative to the feet (12) or as a function of other biomechanical or performance parameters, such as, but not limited to, vibrating or emitting a sound, and the shape employed to depict the COM (10) may be configured to change or alter colours as a function of the position of the COM (10) or as a function of other biomechanical or performance parameters.

The display (1) in FIG. 3 further comprises other elements, which may be comprised or not in other embodiments of the invention, or said embodiments may include more elements which are not depicted in FIG. 3. For instance, in FIG. 3 the position of the feet (12) of the patient are displayed in the shape of shoe footprints, however, they may be represented through different shapes, in different sizes and with different colours. The display (1) also may be configured to vibrate or emit a sound as a function of the position of the feet (12) of the patient. The display (1) shown in FIG. 3 comprises more elements, such as a horizontal, semi-transparent indicator (14), in the shape of a rectangle, that may follow the position of the COM (10) along the anterior-posterior direction, and a vertical, semi-transparent indicator (16), in the shape of a rectangle, that may follow the position of the COM (10) along the medial-lateral direction. Alternatively, the semi-transparent indicators (14 and 16) may represent a target area along the anterior-posterior and the medial-lateral directions, respectively, and therefore it is the COM (10), displaced by the movement of the user, which shall follow the indicators. Additionally, said, indicators may get a reduced size to increase the precision required to follow them, for instance when the user improves balance and gait, and may be modified by the clinician to set up the training. For example, as shown in FIG. 3 the user shall locate the COM (10) on the upper right corner in order for the system to assist walking to perform a particular action, such as taking a further step. FIG. 3 shows a background image with the left foot in the front, i.e., anterior position, and the right foot in the back, i.e., posterior position. However, it is noted that other background images such as the right foot in the front, and the left foot in the back, are possible, as it can be appreciated on FIG. 2. Furthermore, a background image may be displayed with both feet in the middle, next to each other, or with both feet in any possible position relative to each other. It is also noted that in some embodiments, an animation of the feet may be displayed, instead of static background images.

We would like to note that both indicators (14 and 16) may adopt different shapes, different colours, different opacities, and they may follow the position of the COM (10) proportionally, or displaced between a number of fixed position, for example two positions for each direction, which in the case of the anterior-posterior direction would be front and back, and in the case of the medial-lateral direction would be the right and left. In some embodiments there may be only one position in the anterior-posterior direction, the front one, or three positions for each direction, which in the case of the anterior-posterior direction would be front, middle and back, and in the case of the medial-lateral direction would be the right, middle and left. They also may be changed, in position, shape, colour or opacity, among others, by use of the settings provided by the display (1), according to clinician's directives, automatically, according to a pre-set routine or to the user progress, and/or randomly. FIG. 3 also displays the setting mode (18), in this case it reads as “walking”, but it could be set to a different setting mode, or it could be obviated, or only comprise one mode. Apart from the setting mode, the terminal display (1) may show usage metrics, like the number of steps, walking distance, cadence, standing/walking time, or performance metrics such as step length or foot clearance measurements, which may be updated and displayed at each step while the patient is using the system (4). The display (1) may also allow adjusting all gait settings that modify the walking pattern of the system to assist walking in real-time while the user is walking, and changes are applied when the next step is taken. Examples of these settings are the foot clearance, step length, trunk inclination or the amount of assistance provided at each anterior-posterior and/or medial-lateral step.

In a preferred embodiment of the first aspect of the invention, the terminal display (1) is configured to display the system status. Examples of said system status may include, but are not restricted to, battery level, motor status, actuator health, sensor connectivity, error messages, system uptime, software version, mode of operation, weight load, joint stiffness levels, brake status, temperature readings, calibration status, and safety lock status.

Advantageously, the real-time display of system status serves as a critical fail-safe, enabling constant monitoring to ensure the mechanical and operational integrity of the device. Typically monitored by clinicians, these indicators pre-emptively flag any issues that may compromise the safety or effectiveness of the assistive walking system. The system status is important for the safe use of the device, and it must be continuously monitored by at least one of the users.

In a preferred embodiment of the first aspect of the invention, the terminal display (1) is configured to display biomechanical information. Examples of said biomechanical information may include, but are not restricted to, the user's center of mass, pelvic tilt, knee angle, hip angle, ankle angle, ground reaction forces, torque distribution, posture alignment, body weight distribution, lumbosacral angle, foot pressure distribution, and spinal curvature.

Advantageously, the real-time biomechanical information serves a dual purpose: clinicians can leverage this data to provide immediate feedback on posture and gait mechanics, and patients can use the information for self-correction and improvement. This type of real-time information viewed by the patient can help them to make up for a lack of proprioceptive feedback and allows them to improve their walking performance.

In a preferred embodiment of the first aspect of the invention, the terminal display (1) is configured to display usage metrics. Examples of said usage metrics may include, but are not restricted to, the number of steps, walking distance, cadence, standing/walking time, ground reaction forces, velocity and acceleration, stride length, step width, swing time, stance time, energy expenditure (calories burned), symmetry ratios (e.g. between left and right limbs), kinematic angles (e.g. hip, knee, ankle angles), center of mass displacement, balance metrics (e.g. sway area, sway velocity), gait cycle time, muscle activation levels (e.g., via electromyography), joint torques, pressure distribution (e.g., peak pressures, contact areas), incline and decline angles (for walking on slopes), task-specific metrics (e.g., time to complete a particular walking task), quality of movement indices (e.g., smoothness of motion), variability metrics (e.g., stride-to-stride variability), fatigue indicators (e.g., change in metrics over time).

Advantageously, the display of a broad array of usage metrics such as those enumerated enhances both patient engagement and clinical utility. These metrics serve to incentivize patient adherence to therapeutic regimens by providing quantifiable markers of progress.

Simultaneously, they offer clinicians a rich dataset for refining individualized treatment plans, thereby improving the rehabilitation process. This multifaceted functionality elevates the efficacy of gait training and amplifies the versatility of the system to assist walking, also, this data can be used to track patients' evolution over time with visual progress plots.

In a preferred embodiment of the first aspect of the invention, the terminal display (1) is configured to display performance metrics. Examples of said performance metrics may include, but are not restricted to, step length, foot clearance measurements, stride symmetry, gait speed, swing phase duration, double support time, ground contact time, knee flexion peak, ankle dorsiflexion, step height, and torque applied at joints. These metrics can be updated and displayed continuously, offering real-time values for the last step taken or an average value compiled from the most recent set of steps or walking sessions.

Advantageously, the real-time presentation of these performance metrics allows for immediate therapeutic intervention to refine and improve gait mechanics. It facilitates a data-driven approach to gait therapy, enabling clinicians to tailor interventions for more natural gait patterns. Moreover, the immediate availability of these metrics enables real-time adjustments, enhancing the effectiveness and efficiency of rehabilitative efforts.

In a preferred embodiment of the first aspect of the invention, the terminal display (1) is configured to display and allow adjusting all gait settings that modify the walking pattern of the system to assist walking. Said gait settings may be provided in real-time while the user is walking and changes may be applied before, after, or when the next step is taken. Examples of said settings may include, but are not restricted to, trunk inclination, the amount of assistance provided at each step, joint assistance levels, step length, cadence, foot clearance, swing phase duration, ankle dorsiflexion angle, knee flexion/extension parameters, hip abduction/adduction limits, and ground reaction forces.

For instance, see FIG. 3, the gait settings may be provided in the form of preconfigured step modes (13) that may be selected or modified by the clinician, and/or triggered by the movement of the patient. Some examples of these step modes, but not limited to, are Manual Step Mode, that gives full control to the therapist, the Center of Mass Step Mode, which is triggered by the patient when they shift their weight to the correct position, and the Dynamic Step Mode, wherein the exoskeleton triggers a step when it detects a forward motion of the pelvis related to the natural movement of walking, and takes a step on the leg that is behind.

Advantageously, the real-time adjustability of these gait settings obviates the need for session interruptions, thereby optimizing the therapy time available. Also, the different possibilities to trigger the assistance from the system (4) is very convenient to gradually increase the difficulty and the autonomy of the patients. This ensures a maximal dosage of exoskeleton-assisted walking within a given therapy session. It also allows for instant customization based on real-time performance metrics and biomechanical feedback, enhancing the therapeutic outcomes through a data-driven approach and through real-time adaptability of the training sessions.

It is noted that in a preferred embodiment the information and settings above mentioned may be introduced in any combination possible. Therefore, the terminal display (1) may be configured to display and/or store system status information, biomechanical information, usage metrics, performance metrics, and/or gait settings, and preferably it allows adjusting gait settings. This way, the terminal display (1) may comprise all the advantages explained before related to displaying, storing or modifying information and settings related to the system to assist walking (4), or the usage of said system (4).

In a preferred embodiment of the first aspect of the invention, the terminal display (1) is configured to be removably attached to the system to assist walking (4) through magnetic means (3).

It is noted that the magnetic means (3) may comprise permanent magnets, ceramic magnets, magnet assemblies involving rare earth elements or other magnetic materials suitable for creating a secure and stable attachment. Exemplary materials include, but are not limited to, ferromagnetic materials, such as Iron, Nickel, Cobalt, Alnico, Ferrite, ferrimagnetic materials, such as Magnetite, Yttrium Iron Garnet, Manganese Ferrite, Nickel Ferrite, Lithium Ferrite, high magnetic strength materials such as neodymium or Praseodymium, or samarium-cobalt magnets, among others, for high-temperature resistance. It is further noted that the magnets (3) may come in different shapes and sizes to optimize the magnetic attraction. For example, cylindrical or disc-shaped magnets may be employed to provide a focused point of contact, while rectangular magnets may offer a broader contact area. The dimensions of these magnets can be varied according to specific requirements for magnetic strength and stability. Said magnets (3) may be located on various segments of the walking assistance, preferably at the back, such as in the lumbar, middle or upper back parts. Placing the magnets (3) at the rear of the system to assist walking minimizes interference with the system's mechanical operation, however they may be placed elsewhere to provide different functionality, such as the front, the head rest, the laterals, etc. In some embodiments, magnets (3) may be present on both the terminal display (1) (Or the terminal display's case) and the walking assistance system (4). In alternative configurations, magnets could be located only on the terminal display (1) or the terminal display's case, with the walking assistance system (4) incorporating a ferromagnetic material to facilitate the magnetic attachment. To further augment the stability of the magnetically attached display, the walking assistance system may include additional mechanical support (2) features. These may include, but are not limited to, lockable fasteners, or safety straps designed to prevent unintentional detachment of the terminal display (1), or just protrusions that adjust to the shape of the display (1). Additionally, in some embodiments the terminal display (1) may include visual, auditory, or tactile indicators confirming a successful magnetic attachment. This feature enhances user confidence in the integrity of the connection. The magnetic attachment mechanism may also permit angular or positional adjustments of the terminal display (1). This is particularly useful for accommodating different user heights and postures. It is also noted that the magnetic means (3) may comprise electromagnets. The electromagnets may be configured to have variable strength and directionality, enabling a more dynamic control over the magnetic field. Materials for the electromagnets may include, but are not limited to, copper, aluminium, iron, or an alloy thereof. In a further embodiment, the windings of the electromagnet may be insulated using materials such as polyurethane, Polyvinyl Chloride, Teflon, or Kapton. It is also contemplated that the electromagnets may be designed with different coil geometries, such as solenoidal, toroidal, or flat spiral configurations, to suit specific applications.

Advantageously, the magnetic attachment mechanism (3) for removably connecting the terminal display (1) to the walking assistance system (4) simplifies installation and removal, enhances user adaptability, and ensures a robust and secure fit. This reduces both wear and tear and complexity, offering economic benefits in terms of longevity and manufacturing costs. Overall, the magnetic attachment (3) offers a versatile, reliable, and user-friendly method of attaching the terminal display (1).

In a more preferred embodiment of the terminal display (1) of the invention, the magnetic means (3) comprised in the system to assist walking (4) for a 3×3 grid of magnets, preferably squared, in which each of them may adopt different polarizations, therefore some may interface with the display (1) through a North magnetic pole while others may interface with a South magnetic pole. The terminal display (1), or the case of the display (1), may comprise a complementary polarization to be able to engage with the system (4). Advantageously, this allows to attach a particular display (1) with a system (4) that presents the same combination, while avoiding being attached to other systems (4), personalizing this way the use and adding security.

In a preferred embodiment of the invention, the position of the COM (10) relative to the position of the user's feet (12) is computed by the control unit of the system to assist walking.

It is noted that the control unit may serve to integrate, process, and interpret sensor data before providing output commands to the system's actuating elements. The control unit may be constructed based on various types of microcontrollers, microprocessors or circuit boards. Alternatively, more specialized units such as Digital Signal Processors (DSPs) or Field-Programmable Gate Arrays (FPGAs) could be employed for specific computational tasks related to COM calculations. Within the control unit, various algorithms could be employed for computing the position of the COM (10). These algorithms may employ kinematic equations, machine learning models, or sensor fusion techniques, depending on the desired accuracy and responsiveness. Optimization for real-time computation is preferable to ensure immediate feedback to the user. The control unit may be located in different segments of the walking assistance system for optimized functionality and ease of access. Possible locations include the lumbar segment, for centralized processing, or within the thigh or shank segments for localized control. Consideration for the control unit's location also factors in weight distribution, user comfort, and accessibility for maintenance or updates. The control unit may communicate wirelessly with the terminal display (1), employing various secure and low-latency communication protocols. These protocols may include, but are not limited to, Bluetooth, Wi-Fi, or specialized industrial communication standards like Zigbee or LoRa. Security measures such as encryption and authentication may also be incorporated to protect user data. Furthermore, the control unit may interface with multiple sensors located throughout the walking assistance system. These sensors could include, but are not limited to, angle sensors, orientation sensors, encoders, accelerometers, gyroscopes, force sensors, or pressure sensors, each contributing data for accurate calculation of the COM (10) and feet position (12). Additionally, for enhanced reliability, the control unit may be designed with redundant sub-systems that can take over in case of a primary system failure. Additionally, fail-safe algorithms can be included to bring the system to a safe state in case of unexpected anomalies.

Advantageously, the control unit's specialized capability to compute the Center of Mass (COM) (10) position significantly augments the system's efficacy in walking assistance, and increases the computational speed compared to communicating wirelessly with an external unit, which improves the ability of calculating the COM (10) position in real time.

In a preferred alternative embodiment of the first aspect of the invention, the terminal display (1) further comprises a processing unit, and the position of the COM (10) relative to the position of the user's feet (12) is computed by the processing unit of the terminal display (1).

It is noted that the processing unit within the terminal display (1) may range from application-specific integrated circuits (ASICs) for optimized performance to general-purpose microprocessors for broader computational capabilities. The unit may also integrate with Graphic Processing Units (GPUs) for faster mathematical calculations relevant to COM positioning. It is further noted that the terminal display (1) may employ a variety of software frameworks suitable for real-time data processing, visualization, and control. These could include native operating systems like Android or iOS for smartphones and tablets, or specialized embedded software for dedicated PDAs or custom display units. Additionally, the processing unit within the terminal display (1) may communicate wirelessly using secure and low-latency protocols such as Bluetooth, Wi-Fi, or Zigbee to interact with the walking assistance system, ensuring seamless data flow and control.

Advantageously, the integration of a processing unit within the terminal display (1) offers a decentralized approach to computing the COM (10), thereby providing enhanced system reliability and flexibility. This architecture allows users to use existing high-performance devices like smartphones or tablets, reducing the overall cost and increasing the system's adaptability for different user preferences and needs. It also allows for software-based updates, making the system more future-proof and versatile.

In a preferred embodiment of the invention, the terminal display (1) is adapted to be removably attached to a system to assist walking (4) that further comprises i) at least a pair of angle sensors suitable respectively to measure or calculate the angle between a shank segment and a thigh segment, and ii) at least a triplet of orientation sensors suitable to measure or calculate the orientation of the thigh segments and the lumbar segment. Wherein the control unit is further configured for processing the angle sensors and the orientation sensors readings, and wherein the position of the COM (10) relative to the position of the user's feet (12) is computed based at least on the angle's readings of each of the angle sensors, the roll and pitch angles readings of each of the orientation sensors, the length of the shank and thigh segments, the distance between the thigh segments at the hip level, and the height of the COM (10) of the user relative to the center of the coordinate system chosen, such as the middle point in the hip of the user.

It is noted that instead of the triplet of orientation sensors, one orientation sensor and two angle sensors may be employed. For instance, the one orientation sensor may be placed in the lumbar segment, and the two angle sensors may be placed each one in a hip joint. This way, the COM (10) projection could also be computed. Note that in this case the roll angle of the lumbar segment would be used as the roll angle of the thigh segments.

It is also noted that the triplet of orientation sensors may be a triplet of inertial measurement unit (IMU) sensors, wherein said sensors are comprised in the system to assist walking (4) to which the terminal display (1) is attached. The utilization of inertial measurement unit sensors as the orientation sensors in a triplet configuration offers superior accuracy in capturing three-dimensional orientation data for the walking assistance system (4) to which the terminal display (1) is attached. These sensors provide real-time gyroscopic and accelerometric data, allowing for a comprehensive understanding of the user's spatial orientation and movement dynamics.

It is further noted that the readings from other combinations of sensors may be employed to determine the position of the COM (10) relative to the position of the user's feet (12). For instance, there may be at least an orientation sensor or IMU suitable to measure or calculate the orientation of the lumbar segment, at least a pair of angle sensors or encoders suitable respectively to measure or calculate the angle between a shank segment and a thigh segment, and at least a pair of angle sensors or encoders suitable respectively to measure or calculate the angle between a thigh segment and a lumbar segment. Alternatively, there may be at least an orientation sensor or IMU suitable to measure or calculate the orientation of the lumbar segment, at least a pair of orientation sensor or IMU suitable respectively to measure or calculate the orientation of the thigh segments, and at least a pair of an orientation sensors or IMUs suitable respectively to measure or calculate the orientation of the shank segments. In another embodiment, there may be at least a pair of orientation sensors or IMUs suitable respectively to measure or calculate the orientation of the shank segments, at least a pair of angle sensors or encoders suitable respectively to measure or calculate the angle between a shank segment and a thigh segment, and at least a pair of angle sensors or encoders suitable respectively to measure or calculate the angle between a thigh segment and a lumbar segment. In an alternative embodiment, there may be at least a pair of orientation sensors or IMUs suitable respectively to measure or calculate the orientation of the thigh segments, at least a pair of angle sensors or encoders suitable respectively to measure or calculate the angle between a shank segment and a thigh segment, and at least a pair of angle sensors or encoders suitable respectively to measure or calculate the angle between a thigh segment and a lumbar segment. Alternatively, in some embodiments there may be at least a pair of orientation sensors or IMUs suitable respectively to measure or calculate the orientation of the thigh segments, at least a pair of an orientation sensor or IMU suitable respectively to measure or calculate the orientation of the shank segments, and at least a pair of angle sensors or encoders suitable respectively to measure or calculate the angle between a thigh segment and a lumbar segment. Also, in some other embodiments there may be at least an orientation sensor or IMU suitable to measure or calculate the orientation of the lumbar segment, at least a pair of orientation sensor or IMU suitable respectively to measure or calculate the orientation of the shank segments, at least a pair of angle sensors or encoders suitable respectively to measure or calculate the angle between a shank segment and a thigh segment, and/or at least a pair of angle sensors or encoders suitable respectively to measure or calculate the angle between a thigh segment and a lumbar segment. It is noted that the skilled person may find other equivalent alternative embodiments with different configurations and/or combinations of orientation and angle sensors in the different segments of the system (4).

The roll angle may be obtained from an inertial measurement unit (IMU) sensor directly if the IMU has a sensor fusion algorithm to compute Euler angles. Alternatively, the Euler angles may be calculated by the processing unit from the sensor's readings. Also, in case that the thigh segments only had a joint angle sensor, so no thigh roll angle is measured, the roll angle measured with the IMU sensor of the lumbar segment could be used for the COM (10) calculations.

Therefore, the COM (10) may be calculated by different sensor's configurations that do not comprise sole pressure sensors, however, we would like to note that sole pressure sensors may also be employed to calculate the COM (10) in alternative embodiments of the invention.

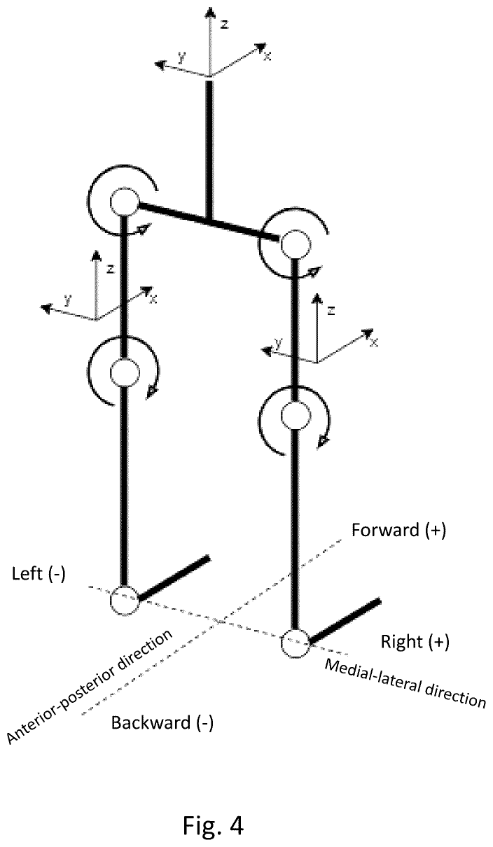

FIG. 4 shows a detailed representation of an exemplary sign convention that may be employed during COM (10) calculations. It is noted that other notations and conventions may be employed to implement the invention, as long as they are coherent with the coordinate system. According to the coordinate system illustrated in FIG. 4, pitch angle is defined as the rotation around the Y axis of the segment, wherein positive rotation follows the right-hand rule. According to FIG. 4, roll angle is defined as the rotation around the X axis of the segment, wherein positive rotation follows the right-hand rule.

It is noted that the height of the COM (10) of the user relative to the center of the coordinate system chosen, such as the middle point in the hip of the user, may be taken as a fixed distance from the center of the coordinate system to the vertical position of the COM (10), for instance when the user is standing in an upright position. Said distance may be obtained in different ways, such as, but not limited to, direct measurements, morphological studies of the patient, it may be extracted from tabulated values with respect to height, weight or limbs length, calculated based on an adequate algorithm or estimated according to formulas, among other options.

Advantageously, this way of determining the COM (10) is lightweight and convenient, and offers many alternative configurations and combinations of sensors that may adapt to different hardware requirements. The weight and complexity of the system to assist walking is reduced by using common sensors that are typically placed in the joints and segments of a regular exoskeleton, such as angle, orientation and/or IMU sensors, without the need to employ additional sensors such as sole pressure sensors, that require a foot segment and add a substantial amount of weight and complexity to the system (4), and make it more difficult to wear to the user. Also, the cable connecting to the foot segment would not allow removing said segment for donning and/or transportation, therefore it is convenient to find alternative systems (4) that do not require said foot segments.

In a preferred embodiment of the invention, the position of the COM (10) of the user is displayed in the terminal display (1) as a top-view projection relative to the position of the user's feet (12). See FIGS. 2 and 3 as examples of an embodiment of said top-view projection of the COM (10) relative to the user's feet (12) display in the terminal display (1).

When referring to the user' feet, it must be understood in its broadest sense. The skilled person may envisage many ways in which the user's feet may be identified for the purpose of computing a reference for the COM, such as the ankle, sole, center of mass of the feet, heel, toes, means length of the feet, or any combination thereof. All of these and other references to any part and/or spatial property associated to the feet, are comprised within the disclosure of the present invention. It is noted that the top-view projection can be displayed in diverse visual formats to accommodate various user preferences and contexts. For instance, the display (1) may show a straightforward 2D representation, using simple shapes or icons to denote the COM (10) and feet position. Alternatively, more intricate 3D models can be used, possibly including a full-body avatar of the user in motion, providing a more immersive experience. It is further noted that the visual representation may not necessarily maintain a one-to-one scale with actual body dimensions, and it may be bigger or smaller. In some embodiments, the feet may be displayed in exaggerated proportions for emphasis, or the COM (10) may be magnified to aid in user comprehension. Also, the COM (10) position could be intentionally exaggerated to give the patient the impression that their performance is worse than it actually is, in a technique known as error amplification. The representation can also be dynamic, changing size or proportions based on specific user actions or system requirements. Also, abstract symbols or icons could be utilized to denote the COM (10) and feet (12). For example, a circle may refer to the COM (10), while foot-shaped icons may indicate the user's feet. These abstract symbols can be color-coded, animated, or augmented with textual cues to convey additional information, such as COM (10) stability or directional movement. Furthermore, the top-view projection could also be augmented with additional metrics or graphical overlays that provide real-time or historical data relevant to walking assistance. This could include directional arrows, stability zones, or pace counters, among others.

It is further noted that in some embodiments the top-view projection of the patient's COM (10) may be estimated using: i) roll and pitch angles of the left/right thigh and lumbar segments measured with inertial measurement unit (IMU) sensors, ii) left/right knee angles measured with encoders and, iii) thigh and shank lengths, hip width and the height of the user's COM (10), which is estimated from the shank and thigh segment measurements.

Advantageously, by estimating the top-view projection of the patient's COM (10), the top-view projection of the patient's COM may be displayed as a moving object on the terminal display (1), and the user can see continuous feedback as they move their body. This can be used to train specific movements with better visual feedback, which they may have had trouble performing previously due to a lack of sensation in their lower limbs. In addition to the COM (1) projection, the terminal display (1) may display the position of the patient's feet (12), for instance showing which leg is in front or if both legs are next to each other. An example of how this type of information may be displayed is shown in FIGS. 2 and 3. The same COM feedback information in the terminal display (1) may be used to improve the patient weight shifting to perform steps. This allows for steps to be initiated when the patient shifts their weight forward and laterally, crossing a threshold limit that can be customised by the therapist through the terminal display's software. Therefore, the top-view projection of the COM (10) relative to the user's feet (12) offers an intuitive and versatile means of conveying complex biomechanical data. This enhances user awareness, engagement, and effective utilization of the walking assistance system. Additionally, the system to assist walking (4) or exoskeleton may give audio feedback when each threshold is crossed.

In a preferred embodiment of the terminal display (1) of the invention, the position of the COM (10) top-view projection relative to the position of the user's feet (12) is computed based on the height and in the orientation of the COM (10) of the user relative to the center of the coordinate system, such as, for instance, the middle point in the hip of the user. It is noted that the height of the COM (10) of the user may be taken as a fixed distance from center of the coordinate system to the vertical position of the COM (10) when the user is standing in an upright position, preferably with their arms at their sides. Said distance may be obtained in different ways, such as, but not limited to, direct measurements, morphological studies of the patient, extracted from tabulated values with respect to height, weight or limbs length or estimated according to formulas, among other options.

Advantageously, the computation of the top-view projection of the Center of Mass (COM) (10) based on its height and in its orientation relative to the user's feet (12) introduces additional biomechanical accuracy to the walking assistance system (4). This height-based computation enables more precise and context-sensitive visualizations, enhancing the user's spatial awareness and thereby contributing to safer and more effective walking assistance. This feature increases the system's adaptability to various user conditions and activities, broadening its applicability and market appeal.

According to an even more preferred embodiment of the terminal display (1) of the invention, the height of the COM (10) of the user is computed based on the shank and thigh segments length measurements. It is noted that in some embodiments said lengths may vary, automatically or manually, and their length may be automatically measured by the system to assist walking (4). Advantageously, this allows for a direct and straight forward measurement of the height of the COM (10).

In an even more preferred embodiment of the terminal display (1) of the invention, the position of the COM (10) top-view projection relative to the position of the user's feet (12) is computed in both the anterior-posterior and medial-lateral directions. Advantageously this allows for a precise location of the COM (10) in the horizontal plane.

In another more preferred embodiment of the terminal display (1) of the invention, the COM (10) top-view projection relative to the position of the user's feet (12), Proj Ap, in the anterior-posterior direction is computed as:

$$P r o {j}_{A P} = {P}_{C O {M}_{A P}} - \frac{{P}_{{LeftFoot}_{A P}} + {P}_{R i g h t F o o {t}_{A P}}}{2}$$

wherein P_{COM_AP} is the position of the COM (10) projected in the anterior-posterior direction, P_{Left Foot_AP} is the position of the left foot projected in the anterior-posterior direction and P_{Right Foot_AP} is the position of the right foot projected in the anterior-posterior direction, and wherein each of the positions are computed according to a coordinate system, preferably wherein the coordinate system is centered in the middle of the hip of the user, wherein the hip of the user may be computed as the line between the thigh segments at the hip level.

In an even more preferred embodiment of the terminal display (1) of the invention, the COM (10) top-view projection relative to the position of the user's feet (12) in the anterior-posterior direction, Proj_{AP}, is normalized by dividing over the distance between both feet (12), D_{Foot_AP}, projected in the anterior-posterior direction. It is noted that D_{Foot_AP} may be multiplied or divided by a numeric factor in order to display the COM (10) top view projection inside a desired area. This factor may adopt any real value. Preferably said distance D_{Foot_AP} is divided by a factor of two.

In a more preferred embodiment of the terminal display (1) of the invention, the COM (10) top-view projection relative to the position of the user's feet (12), in the anterior-posterior direction, is computed as:

$${Proj}_{A P} = \frac{{P}_{COM \_ AP} - ( {P}_{LeftFoot \_ AP} + {P}_{RightFoot \_ AP} ) / 2}{{D}_{Foot \_ AP} / 2}$$

wherein P_{COM_AP} is the position of the COM (10) related to the frontal inclination of the body trunk projected in the anterior-posterior direction, P_{Left Foot_AP} is the position of the left foot projected in the anterior-posterior direction, P_{Right Foot_AP} is the position of the right foot projected in the anterior-posterior direction, and D_{Foot_AP} is the distance between feet (12) projected in the anterior-posterior direction, and wherein each of the positions are computed according to a coordinate system, preferably wherein the coordinate system is centered in the middle of the hip of the user, wherein the hip of the user may be computed as the line between the thigh segments at the hip level.

It is noted that said position of the COM (10) top-view projection relative to the position of the user's feet (12), may be represented as a distance with respect to the center of the coordinate system, the middle of the hip of the user, and/or the middle point between the feet (12). It is also noted that the COM (10) projection may be calculated as a function of the position of the feet (12) with respect to the center of the coordinate system, wherein the position of the feet (12) may be calculated from the signals received from the plurality of sensors. It is further noted that the projection of the COM (10) in the anterior-posterior direction may be normalized with respect to the distance between the feet (12) in said direction.

Advantageously, calculating the COM (10) top-view projection relative to the position of the user's feet (12), in the anterior-posterior direction with this simple formula allows for a quick calculation, which facilitates a real time display of the COM (10), the feet (12) of the user, and their relative distance in the anterior-posterior direction.

In another more preferred embodiment of the terminal display (1) of the invention, the COM (10) top-view projection relative to the position of the user's feet (12), in the medial-lateral direction, is computed as

$${Proj}_{ML} = {P}_{{COM}_{ML}} - \frac{{P}_{{LeftFoot}_{ML}} + {P}_{{RightFoot}_{ML}}}{2}$$

wherein P_{COM_ML} is the position of the COM (10) projected in the medial-lateral direction, P_{Left Foot_ML} is the position of the left foot projected in the medial-lateral direction and P_{Right Foot_ML} is the position of the right foot projected in the medial-lateral direction, wherein each of the positions are computed according to a coordinate system, preferably wherein the coordinate system is centered in the middle of the hip of the user, wherein the hip of the user may be computed as the line between the thigh segments at the hip level.

In an even more preferred embodiment of the terminal display (1) of the invention, the COM (10) top-view projection relative to the position of the user's feet (12) in the medial-lateral direction, Proj_{ML}, is normalized by dividing over the distance between both feet (12), D_{Foot_ML}, projected in the medial-lateral direction and computed according to a coordinate system, wherein said coordinated system is preferably centered in the middle of the hip of the user. It is noted that D_{Foot_ML} may be multiplied or divided by a numeric factor in order to display the COM (10) top view projection inside a desired area. This factor may adopt any real value. Preferably said distance D_{Foot_ML} is divided by a factor of two.

Therefore, in an even more preferred embodiment of the terminal display (1) of the invention, the COM (10) top-view projection relative to the position of the user's feet (12), in the medial-lateral direction, may be computed as:

$${Proj}_{ML} = \frac{{P}_{COM \_ ML} - ( {P}_{LeftFoot \_ ML} + {P}_{RightFoot \_ ML} ) / 2}{{D}_{Foot \_ ML} / 2} ;$$

wherein P_{COM_ML i}s the position of the COM (10) related to the lateral inclination of the body trunk projected in the medial-lateral direction, P_{Left Foot_ML} is the position of the left foot projected in the medial-lateral direction, P_{Right Foot_ML} is the position of the right foot projected in the medial-lateral direction, and D_{Foot_ML} is the distance between feet (12) in the medial-lateral direction and wherein each of the positions are computed according to a coordinate system, preferably wherein the coordinate system is centered in the middle of the hip of the user, wherein the hip of the user may be computed as the line between the thigh segments at the hip level.

It is noted that said position of the COM (10) top-view projection relative to the position of the user's feet (12), may be represented as a distance with respect to the center of the coordinate system, the middle of the hip of the user, and/or the middle point between the feet (12). It is also noted that the COM (10) projection may be calculated as a function of the position of the feet (12) with respect to the center of the coordinate system, wherein the position of the feet (12) may be calculated from the signals received from the plurality of sensors. It is further noted that the projection of the COM (10) in the medial-lateral direction may be normalized with respect to the distance between the feet (12) in said direction.

Advantageously, calculating the top-view projection of the COM (10) in the medial-lateral direction with this simple formula allows for a quick calculation, which facilitates a real time display of the COM (10), the feet (12) of the user and their relative distance in the medial-lateral direction.

In an even more preferred embodiment of the terminal display (1) of the invention, the coordinate system is centered in the middle of the hip of the user, preferably wherein the hip of the user is computed as the line between the thigh segments at the hip level.

It is noted that the relative distance between the COM (10) top-view projection and the feet (12) positions in both the anterior-posterior and the medial-lateral direction may be displayed in the terminal display (1) with respect to the center of the coordinate system, which may be centered in the middle of the hip of the user. Alternatively, it may be centered in the middle point between the feet (12) of the user. In other embodiments, the center of the coordinate system may be centered at any other point defined relative to the system (4), such as centered around any part of its segments.

Advantageously, this provides a consistent and easy way to calculate the coordinate system.

In a preferred embodiment of the terminal display (1) of the invention, the at least one pair, i.e. at least two, of angle sensors are encoders located at the knee joints connecting respectively a shank segment and a thigh segment, wherein said sensors are comprised in the system to assist walking (4) to which the terminal display (1) is attached.

Advantageously, the incorporation of encoders as angle provides a high level of precision in capturing joint angles and kinematics. This allows for real-time, accurate data input into the walking assistance system (4) to which the terminal display (1) is attached.

According to another preferred embodiment of the terminal display (1) of the invention, one or more of the pair of shank and thigh segments are adjustable in length, wherein the distance between the thigh segments at the hip level is adjustable, and wherein the control unit is further configured for receiving these length and distance values.

It is noted that the adjustability in length and in distance can be achieved through various means, such as, but not limited to, telescoping mechanisms, sliding joints, rotating joints, extendable crossbars, or interchangeable modules. The length of these segments may vary, and be longer or shorter. For instance, they may range from 20 to 80 cm, preferably from 30 to 60 cm, even more preferably from 37 to 49 cm, for the thigh segments, and 20 to 60 cm, preferably from 30 to 50 cm, even more preferably from 34 to 50 cm for the shank segments. The distance between the thigh segments at the hip level may vary as well, and be longer or shorter. For instance, it may range from 20 to 100 cm, preferably from 25 to 70 cm, more preferably from 30 to 60 cm, even more preferably from 35 to 50 cm. Also, in those embodiments in which the system (4) comprises foot segments, the distance from an ankle articulation of the system (4) to the sole of the foot segment in the same leg, may range from 5 to 30 cm, preferably from 10 to 20 cm, even more preferably between 10 and 15 cm. All the length and distance measurements values may vary around a ±25%, a ±20%, a ±15%, a ±10%, or a ±5%. The adjustment could be done manually, such as through pin-lock mechanisms, or automatically, such as through motorized actuators that receive commands from the control unit. In some embodiments, the control unit can utilize these values in its algorithms to provide optimized assistance for the user. The lengths and distances can be inputted manually by the user, or automatically measured by sensors located on the relevant segments. These measurements can then be used by the control unit to compute the user's center of mass (10) (COM) more accurately.

Advantageously, the features provide a system (4) that can be specifically tailored to individual users. The adjustability in the length of the thigh and shank segments, as well as the distance between the thigh segments at the hip level, allows for a custom fit that can lead to increased comfort, better weight distribution, and enhanced mobility for the user. The configuration of the control unit to receive and utilize these adjustable values enables the system to optimize the COM (10) calculations and the usage information gathered, such as the user's walking pattern and stability, improving the overall functionality and effectiveness of the system to assist walking (4).

In a preferred embodiment of the terminal display (1) of the invention, the magnetic means (3) of the terminal display (1) to the system to assist walking (4) are personalized to each respective system (4). In some embodiments, there may be a tailored configuration of magnetic means (3), characterized in that the magnetic attachment is unique and/or personalized to each respective system (4). This uniqueness or personalization may be achieved through a specific arrangement of magnets having differing polarities, configured in a predetermined pattern, such as, for instance, a 3×3 grid disposition, on both the system's (4) mechanical support (2) or detachable means (3) and the corresponding configuration in the terminal display's (1) case with matching or reciprocal magnet's arrangement and polarizations, thereby ensuring a secure and exclusive magnetic coupling between the terminal display (1) and the system to assist walking (4). It is noted that the grid may comprise more or less magnets and have different configurations or even the magnetic means arrangement may not from a grid, and some combinations may include empty slots to increase the number of combinations. Another example of creating this personalization is by using electromagnets in the system to assist walking (4) or the mechanical support (2), that activate when the correct terminal display (1) is approximated to the attachment location, and wherein the terminal display (1) or the case of the terminal display (1) comprises magnetic means. This activation may be produced for instance by communicating by any wireless means such as NFT, Bluetooth, WiFi′ or any other means, that send the signal to activate whenever a corresponding device is nearby or is paired.

Advantageously, the personalized or unique magnetic attachment between the terminal display (1) and the walking assistance system (4) enhances security and reduces the risk of unintended disconnections or mismatches. The tailored configuration of magnetic means (3) ensures that the terminal display (1) is securely and exclusively coupled with its corresponding walking assistance system (4).

In a preferred embodiment of the terminal display (1) of the invention, the terminal display (1) may comprise an external screen, a projector, a virtual reality headset or an augmented reality headset, preferably connected to the system to assist walking (4) wirelessly.

Therefore, the terminal display (1) may comprise an additional screen, such as an LCD, LED, or OLED screen. Alternatively, the terminal display (1) may be a projector, or comprise an additional projector, which may employ different projection technologies, such as DLP, LCD, or LCoS. In another embodiment, the terminal display (1) may be a virtual reality headset or comprise an additional virtual reality headset. The headset may implement various display technologies like OLED or microLED. Yet alternatively, the terminal display (1) may be an augmented reality headset, or comprise an additional augmented reality headset, which may comprise optical see-through displays or video see-through displays. The connection between the terminal display (1) or the additional elements and the system to assist walking (4) may preferably be established wirelessly, utilizing various wireless communication protocols such as, but not limited to, Bluetooth, Wi-Fi, or custom RF solutions. Alternatively, a wired connection may also be used employing connectors like USB, HDMI, or proprietary connectors designed for specific applications. It is noted that any combination of terminal displays (1) herein mentioned may be employed simultaneously or alternatively, therefore adapting to different situations.

Advantageously, the flexibility in the type of terminal display (1) used allows for customization based on user preference and situational requirements. Also, wireless connectivity allows to project the information in a wide variety of displays, even simultaneously so that the clinician and the patient may be receiving information at the same time. These advantages may combine to offer a more user-friendly, adaptable, and future-proof system.

All of the above are fully within the scope of the present disclosure, and are considered to form the basis for alternative embodiments in which one or more combinations of the above described features are applied, without limitation to the specific combination disclosed above. It is therefore understood that the present invention also relates to an exoskeleton according to any of the embodiments of the first aspect of the invention comprising any of the terminal display any of the embodiments of the first aspect of the invention.

In light of this, there will be many alternatives which implement the teaching of the present disclosure. It is expected that one skilled in the art will be able to modify and adapt the above disclosure to suit its own circumstances and requirements within the scope of the present disclosure, while retaining some or all technical effects of the same, either disclosed or derivable from the above, in light of his common general knowledge in this art. All such equivalents, modifications or adaptations fall within the scope of the present disclosure.

### EXAMPLE

Here we provide an example of used equations to calculate the position of the COM top-view projection relative to the position of the user's feet (12) is in both the anterior-posterior and medial-lateral directions. We would like to note that there are several different ways in which this can be calculated, and it is not restricted to the example hereby shown. FIG. 4 shows a detailed representation of the sign convention employed in the following examples, it is noted that other notations and conventions may be employed to implement the invention, as long as they are coherent with the coordinate system. According to the coordinate system illustrated in FIG. 4, pitch angle is defined as the rotation around the Y axis, wherein positive rotation follows the right-hand rule. According to FIG. 4, roll angle is defined as the rotation around the X axis, wherein positive rotation follows the right-hand rule.

### Medial-Lateral Direction

$${Proj}_{ML} = \frac{{P}_{COM \_ ML} - ( {P}_{LeftFoot \_ ML} + {P}_{RightFoot \_ ML} ) / 2}{{D}_{Foot \_ ML} / 2}$$

wherein P_{COM_ML} is the position of the COM (10) related to the lateral inclination of the body trunk projected in the medial-lateral direction, P_{Left Foot_ML} is the position of the left foot projected in the medial-lateral direction, P_{Right Foot_ML} is the position of the right foot projected in the medial-lateral direction, and D_{Foot_ML} is the distance between feet (12) in the medial-lateral direction.

Each of the parameters are computed according to the following equations:

$${P}_{COM \_ ML} = {Body}_{COM} \cdot sin ( {Trunk}_{Roll} )$$

Wherein Body_{COM} is the height of the COM (10) relative to the coordinate center in the middle point of the hip of the user, and Trunk_{Roll} is the lateral inclination of the body trunk.

$${P}_{LeftFoot \_ ML} = - ( \frac{{Hip}_{Width}}{2} ) \cdot cos ( {Trunk}_{R o l l} ) - {Brace}_{Length} \cdot sin ( {Thigh}_{RollLeft} )$$

Wherein Hip_{Width} is the width of the hip, Brace_{Length} is the length of the thigh plus the length of the shank for any of the two legs, preferably it also includes the length from the ankle articulation to the sole of the exoskeleton. It is noted that in other embodiments Brace_{Length} may be the different for the left and right legs, in which case it may be convenient to separate it into one value for each leg. Finally, Thigh_{Roll} is the lateral inclination of the thigh.

$${P}_{RightFoot \_ ML} = - ( \frac{{Hip}_{Width}}{2} ) \cdot cos ( {Trunk}_{R o l l} ) - {Brace}_{Length} \cdot sin ( {Thigh}_{RollRight} )$$

### And:

$${D}_{Foot \_ ML} = \vert {P}_{{LeftFoot}_{ML}} - {P}_{{RightFoot}_{ML}} \vert$$

### Anterior-Posterior Direction

$${Proj}_{AP} = \frac{{P}_{COM \_ AP} - ( {P}_{LeftFoot \_ AP} + {P}_{RightFoot \_ AP} ) / 2}{{D}_{Foot \_ AP} / 2}$$

wherein P_{COM_AP} is the position of the COM (10) related to the frontal inclination of the body trunk projected in the anterior-posterior direction, P_{Left Foot_AP} is the position of the left foot projected in the anterior-posterior direction, P_{Right Foot_AP} is the position of the right foot projected in the anterior-posterior direction, and D_{Foot_AP} is the distance between feet (12) projected in the anterior-posterior direction, and wherein each of the positions are computed according to the following equations:

$${P}_{COM \_ AP} = {Body}_{COM} \cdot sin ( {Trunk}_{Roll} )$$

Wherein Body_{COM} is again the height of the COM (10) relative to the coordinate center in the middle point of the hip of the user and Trunk_{Pitch} is the frontal inclination of the body trunk.

$${P}_{LeftFoot \_ AP} = {Thigh}_{Len gth} \cdot sin ( {Thigh}_{PitchLeft} ) + {Shank}_{Length} \cdot sin ( {Thigh}_{PitchLeft} - {Knee}_{AngleLeft} )$$

Wherein Thigh_{Length} is the length of the thigh, Thigh_{PitchLeft} is the frontal inclination of the left thigh, Shank_{Length} is the length of the shank, and Knee_{AngleLeft} is the angle between the left thigh and the left shank.

$${P}_{RightFoot \_ AP} = {Thigh}_{Len gth} \cdot sin ( {Thigh}_{Pitch Right} ) + {Shank}_{Length} \cdot sin ( {Thigh}_{Pitch Right} - {Knee}_{Angle Right} )$$

Wherein Thigh_{Length} is again the length of the thigh, which may be the same for the right and left legs, Thigh_{PitchRight} is the frontal inclination of the right thigh, Shank_{Length} is again the length of the shank, that may be the same for the right and left legs, and Knee_{AngleRight} is the angle between the right thigh and the right shank.

### And:

$${D}_{Foot \_ AP} = \vert {P}_{{LeftFoot}_{AP}} - {P}_{{RightFoot}_{AP}} \vert$$

And wherein, when both feet are next to each other, in order to avoid dividing by zero (i.e. foot distance in Anterior-posterior direction is 0), we propose to use as the distance between feet the measurement of the hip width.

1. A terminal display adapted to be removably attached to a system to assist walking, wherein the system to assist walking comprises:
a. a lumbar segment,
b. a pair of thigh segments,
c. a pair of shank segments,
d. a plurality of sensors suitable to determine a relative orientation of each segment, and
e. a control unit configured to compute a user's feet relative position from signals received from the plurality of sensors,
wherein the display is configured to display the position of a center of mass (COM) of the user wearing the system to assist walking relative to the position of the user's feet.

2. The terminal display according to claim 1, wherein the display is configured to be removably attached to the system to assist walking through detachable means and is configured to be wirelessly connected to the control unit.

3. The terminal display according to claim 1, wherein the terminal display is configured to be removably attached to the system to assist walking through magnetic means.

4. The terminal display according to claim 1, wherein the position of the COM relative to the position of the user's feet is computed by the control unit.

5. The terminal display according to claim 1, wherein the terminal display further comprises a processing unit, and wherein the position of the COM relative to the position of the user's feet is computed by the processing unit of the terminal display.

6. The terminal display according to claim 1, wherein the system to assist walking further comprises:
f. at least a pair of angle sensors configured to measure or calculate the angle between a shank segment and a thigh segment, and
g. at least a triplet of orientation sensors configured to measure or calculate the orientation of the thigh segments and the lumbar segment,
wherein the control unit is further configured for processing the angle sensors and orientation sensors readings, and
wherein the position of the COM relative to the position of the user's feet is computed based at least on the angle's readings of each of the angle sensors, roll and pitch angles readings of each of the orientation sensors, length of the shank and thigh segments, distance between the thigh segments at a hip level, and height of the COM of a user.

7. The terminal display according to claim 1, wherein the position of the COM of the user is displayed as a top-view projection relative to the position of the user's feet.

8. The terminal display according to claim 6, wherein the height of the COM of the user is computed based on the shank and thigh segments length measurements.

9. The terminal display according to claim 7, wherein the position of the COM top-view projection relative to the position of the user's feet is computed in both an anterior-posterior direction and an medial-lateral direction.

10. The terminal display according to claim 9, wherein the COM top-view projection relative to the position of the user's feet, Pro_{AP}, in the anterior-posterior direction is computed as:
$${Proj}_{AP} = {P}_{COM \_ AP} - \frac{{P}_{LeftFoot \_ AP} + {P}_{RightFoot \_ AP}}{2} ;$$
wherein P_{COM_AP} is the position of the COM projected in the anterior-posterior direction, P_{Left Foot_AP} is the position of a left foot projected in the anterior-posterior direction and P_{Right Foot_AP} is the position of a right foot projected in the anterior-posterior direction, and
wherein each of the positions are computed according to a coordinate system.

11. The terminal display according to claim 10, wherein the COM top-view projection relative to the position of the user's feet in the anterior-posterior direction, Proj_{AP}, is normalized, by dividing over a distance between both feet, D_{Foot_AP}, projected in the anterior-posterior direction.

12. The terminal display according to claim 9, wherein the COM top-view projection relative to the position of the user's feet, Proj_{ML}, in the medial-lateral direction is computed as:
$${Proj}_{ML} = {P}_{COM \_ ML} - \frac{{P}_{LeftFoot \_ ML} + {P}_{RightFoot \_ ML}}{2} ;$$
wherein P_{COM_ML} is the position of the COM projected in the medial-lateral direction, P_{Left Foot_ML} is the position of a left foot projected in the medial-lateral direction and P_{Right Foot_ML} is the position of a right foot projected in the medial-lateral direction, and wherein each of the positions are computed according to a coordinate system.

13. The terminal display according to claim 12, wherein the COM top-view projection relative to the position of the user's feet, in the medial-lateral direction, Proj_{ML}, is normalized, by dividing over a distance between both feet, D_{Foot_ML}, projected in the medial-lateral direction.

14. The terminal display according to claim 11, wherein the coordinate system is centered in the middle of a hip of the user.

15. The terminal display according to claim 6, wherein at least one pair of angle sensors are encoders located at a knee joints connecting respectively a shank segment and a thigh segment.

16. The terminal display according to claim 6, wherein the at least triplet of orientation sensors are inertial measurement unit sensors.

17. The terminal display according to claim 1, wherein one or more of the pair of shank and thigh segments are adjustable in length, wherein a distance between the thigh segments at a hip level is adjustable, and wherein the control unit is further configured for receiving these length and distance values.

18. The terminal display according to claim 3, wherein the magnetic means of the system to assist walking are personalized to each respective system.

19. The terminal display according to claim 1, wherein the terminal display is configured to display and/or store system status information.

20. The terminal display according to claim 1, wherein the terminal display is configured to display and/or store biomechanical information, usage metrics or performance metrics.

21. The terminal display according to claim 1, wherein the terminal display is configured to display and/or store gait.

22. The terminal display according to claim 1, wherein the system to assist walking further comprises a projector.

23. The terminal display according to claim 1, wherein the terminal display may comprise an external screen, a projector, a virtual reality headset or an augmented reality headset.
